(19) United States
(12) Patent Application Publication
(10) Pub. No.: US 2011/0158149 A1
(43) Pub. Date: Jun. 30, 2011

(54) MULTIMEDIA GATEWAY FOR USE IN A NETWORKED HOME ENVIRONMENT

(76) Inventors: Satish Mugulavalli, Bangalore (IN); Ajay Agrawal, Bangalore (IN); Venkatesh Diwakar Tanjore, Bangalore (IN)

(21) Appl. No.: 12/980,393

(22) Filed: Dec. 29, 2010

Related U.S. Application Data
(60) Provisional application No. 61/290,505, filed on Dec. 29, 2009.

(51) Int. Cl. H04H 20/71; H04N 7/18

(52) U.S. Cl. 370/312; 725/74; 725/109

(57) ABSTRACT

Multimedia gateway for use in a networked home environment is disclosed. In one embodiment, in a method for delivering broadcast multimedia content in a networked home environment, a radio frequency (RF) signal is received. The RF signal is then converted into an IP stream. It is determined whether the IP stream is an IP data stream or an IP video stream and based on the outcome of the determination, the IP stream is sent to one or more televisions, one or more computing devices, and/or one or more telephones.

### RELATED APPLICATIONS

Benefit is claimed under 35 U.S.C. 119(e) to U.S. Provisional Application Ser. No. 61/290,505, entitled “MEDIA GATEWAY FOR USE IN A NETWORKED HOME ENVIRONMENT” by inventor SATISH MUGULAVALLI, filed Dec. 29, 2009, which is herein incorporated in its entirety by reference for all purposes.

### FIELD OF TECHNOLOGY

Embodiments of the present subject matter relate to digital communications. More particularly, embodiments of the present subject matter relate to a multimedia gateway for use in a networked home environment.

### BACKGROUND

Set-top boxes (STB) are commonly used to connect Internet televisions (TVs) to a broadcast TV source (e.g., cable TV broadcast source or satellite TV broadcast source) and/or the Internet. With advancement in STBs, additional services, such as online shopping, weather forecasts, telephones, Voice over Internet Protocol (VOIP) and advertising are made available to customers through the Internet TV. Such additional services typically include interfacing of service provider specific STBs with the Internet. Typically, an STB can connect one Internet TV to the broadcast TV source. In a networked home environment that includes a plurality of Internet TVs, each of the Internet TV may need to be connected to the broadcast TV source via a separate service provider specific STB. This may add to the cost of installation where many such STBs are required in the networked home environment having the plurality of Internet TVs. Further, existing STBs may not be able to deliver multiple Internet related services, such as telephones, personal computers, VOIP devices, laptops, and so on to devices other than the plurality of Internet TVs in the networked home environment. Further, the user's are restricted to using only the service provider specific STBs.

### SUMMARY

Multimedia gateway for use in a networked home environment is disclosed. According to one aspect of the present subject matter, in a method for delivering broadcast multimedia content in a networked home environment, a radio frequency (RF) signal is received. The RF signal is then converted into an IP stream. It is determined whether the IP stream is an IP data stream or an IP video stream and based on the outcome of the determination, the IP stream is sent to one or more televisions, one or more computing devices, and/or one or more telephones.

According to another aspect of the present subject matter, a non-transitory computer-readable storage medium for delivering broadcast multimedia content in a networked home environment having instructions that, when executed by a computing device causes the computing device to perform the method described above.

According to yet another aspect of the present subject matter, a system for delivering broadcast multimedia content in a networked home environment includes an RF signal translator for receiving an RF signal, one or more computing devices, a multimedia gateway communicatively coupled to the RF signal translator and the one or more computing devices, and a plurality of set-top boxes (STBs). Each of the STBs is associated with each one of one or more televisions and/or one or more telephones. The RF signal translator converts the RF signal into an IP stream. The multimedia gateway determines whether the IP stream is an IP data stream or an IP video stream and sends the IP stream to one or more of the plurality of STBs associated with the one or more televisions, and/or the one or more telephones, and the one or more computing devices connected to the multimedia gateway based on the outcome of the determination.

According to further another aspect of the present subject matter, a multimedia gateway delivering broadcast multimedia content in a networked home environment includes a processor, and memory coupled to the processor. The memory includes a video processing module, a voice processing module, a data processing module, a media router, and STB. The processor determines whether received IP stream is a IP data stream or a IP video stream and then sends the IP stream to the video processing module for rendering the signal to one or more STBs associated with one or more of televisions, sends the IP stream to the data processing module for rendering the signal to one or more computing devices and sends the IP stream to the voice processing module for rendering the signal to one or more STBs associated with one or more telephones based on the outcome of the determination.

The methods, and systems disclosed herein may be implemented in any means for achieving various aspects, and other features will be apparent from the accompanying drawings and from the detailed description that follow.

### BRIEF DESCRIPTION OF THE DRAWINGS

Embodiments of the present invention are illustrated by way of an example and not limited to the figures of the accompanying drawings, in which like references indicate similar elements and in which:

FIG. 1 illustrates a service environment implementing a multimedia gateway for providing various data, video, voice, and set-top box related services to devices in a networked home environment, according to one embodiment;

FIG. 2 illustrates major modules of the software architecture residing in memory of the multimedia gateway of FIG. 1 according to one embodiment;

FIG. 3 is a block diagram illustrating hardware architecture of the multimedia gateway of FIG. 1, according to one embodiment;

FIG. 4 is a block diagram illustrating more detailed software architecture of the multimedia gateway of FIGS. 1 and 2, according to one embodiment;

FIG. 5 is a block diagram showing interconnectivity between major local area network (LAN) and wide area network (WAN) hardware components for internet protocol (IP) routing in the multimedia gateway of FIG. 1, according to one embodiment; and

FIG. 6 illustrates a process flow chart of an exemplary method for delivering broadcast multimedia content in a networked home environment, such as those shown in FIG. 1, according to one embodiment.

Other features of the present embodiments will be apparent from the accompanying drawings and from the detailed description that follows.

### DETAILED DESCRIPTION

Multimedia gateway for use in a networked home environment is disclosed. In the following detailed description of the embodiments of the present subject matter, reference is made to the accompanying drawings that form a part hereof, and in which are shown by way of illustration specific embodiments in which the present subject matter may be practiced. These embodiments are described in sufficient detail to enable those skilled in the art to practice the present subject matter, and it is to be understood that other embodiments may be utilized and that changes may be made without departing from the scope of the present subject matter. The following detailed description is, therefore, not to be taken in a limiting sense, and the scope of the present subject matter is defined by the appended claims.

The terms “IP video stream” and “video stream” are used interchangeably throughout the document. Further the terms “IP data stream” and “data stream” are used interchangeably throughout the document.

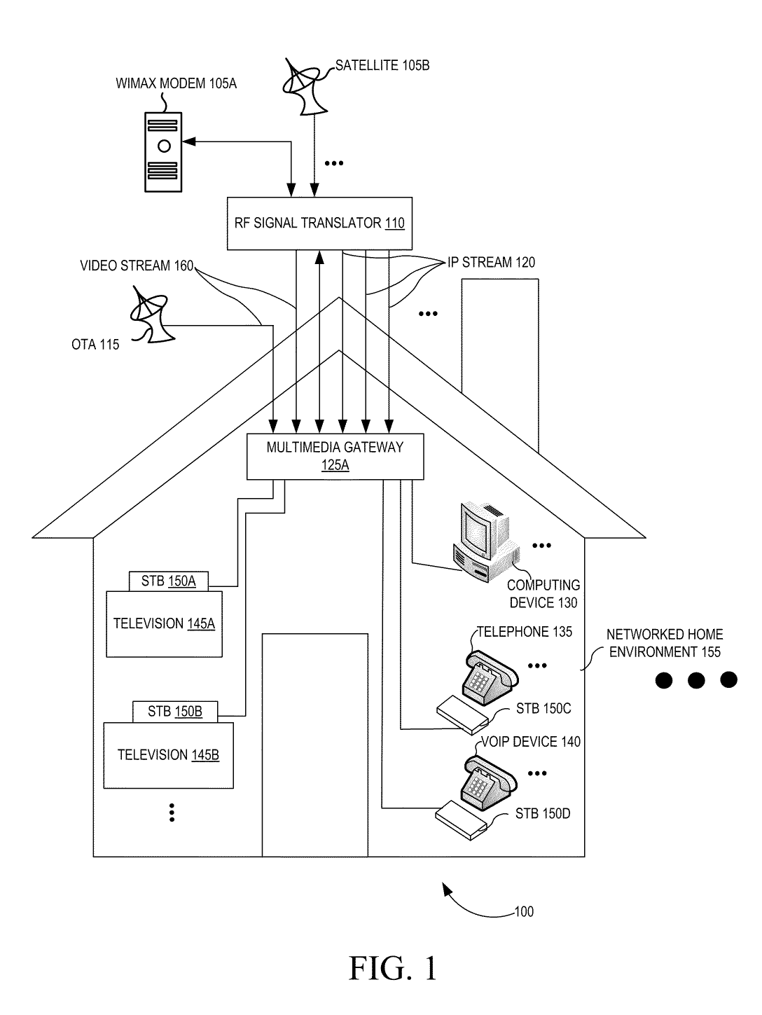

FIG. 1 illustrates a service environment 100 implementing a multimedia gateway 125A for providing various data, video, voice, and set-top box related services to devices in a networked home environment 155, according to one embodiment. As shown, the service environment 100 includes a radio frequency (RF) signal translator 110, which receives RF signals from a plurality of sources. The plurality of sources includes but not limited to a WiMAX modem 105A and a satellite 105B. The WiMAX modem 105A transmits a data stream, whereas the satellite 105B transmits an internet protocol (IP) data stream and an IP video stream which are received by the RF signal translator 110. As illustrated, the RF signal translator 110 receives the IP video stream and the IP data streams from the WiMAX modem 105A and the satellite 105B and converts it to an IP stream including both IP data and IP video streams and sends the IP stream 120 including IP data stream and IP video stream to the multimedia gateway 125A.

The multimedia gateway 125A also receives signals (e.g., IP video streams) directly without passing through the RF signal translator 110 from over the air (OTA) 115. According to an embodiment of the present subject matter, the multimedia gateway 125A determines whether the received IP stream 120 is an IP data stream or an IP video stream and sends the IP stream 120 to set-top boxes (STBs) 150A-D based on the outcome of the determination. The multimedia gateway 125A may also convert the RF signal (e.g., RF video stream received from the satellite 105A) to the IP stream. The STBs 150A-D are associated with one or more televisions 145A-N and one or more telephones 135A-N as illustrated in FIG. 1. The one or more telephones 135A-N may be connected to the multimedia gateway 125A directly without the STBs 150A-D. Also, one or more computing devices 130A-N and one or more VOIP devices 140A-N may be also connected to the multimedia gateway 125A directly without the STBs 150A-D. Although the service environment 100 shown in FIG. 1 is explained with reference to a networked home environment, one skilled in the art can envision that the multimedia gateway 125A can be used in other environments such as multi-tenant units including offices and hotels. Also, it can be envisioned that the STBs may be embedded in the multimedia gateway 125A. The functionality of the embedded STBs can be similar to the standalone STBs 150 A-E.

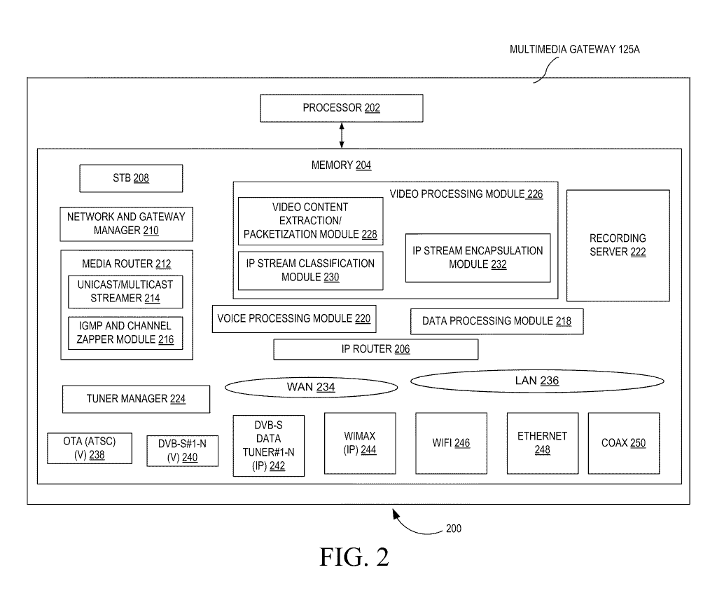

FIG. 2 illustrates major modules of software architecture 200 residing in the multimedia gateway 125A of FIG. 1, according to an embodiment. As shown, the multimedia gateway 125A includes a processor 202, and memory 204 coupled to the processor 202. The memory 204 includes a video processing module 226, a voice processing module 220, a data processing module 218, a media router 212, and a STB 208. According to an embodiment of the present subject matter, the processor 202 determines whether the received IP stream 120 is an IP data stream or an IP video stream. Based on the outcome of the determination, the processor 202 sends the IP stream 120 to the video processing module 226 or the voice processing module 220 or the data processing module 218.

The video processing module 226 renders signal to one or more STBs associated with one or more of televisions. The voice processing module 220 renders signal to one or more STBs associated with one or more telephones. The data processing module 218 renders signal to one or more computing devices connected to the multimedia gateway 125A. The computing devices include but not limited to computers, servers, laptops, STBs, gaming consoles, tablets, and mobile phones.

As illustrated, the video processing module 226 includes a video content extraction/packetization module 228, an IP stream encapsulation module 232, and an IP stream classification module 230. The video content extraction/packetization module 228 extracts the IP video stream from the IP stream 120. The IP stream encapsulation module 232 encapsulates the extracted IP video stream into an IP packet and the IP stream classification module 230 generates a unicast/multicast data using the encapsulated IP packet.

The media router 212 manages and maintains a flow graph that describes video content (linear IPTV channels) flow from the satellite 105B or the OTA 115 to the STBs associated with the one or more televisions. As illustrated, the media router 212 includes an IGMP and channel zapper module 216 and a unicast/multicast streamer 214. The IGMP and channel zapper module 216 maintains a list of channels, tuner parameters, and tunes a required channel in the one or more televisons. The unicast/multicast streamer 214 streams the unicast/multicast data.

Also as shown, the memory 204 includes an IP router 206 which enables Internet connectivity for the STBs 150A-D in the networked home environment 155 through a WAN interface 234 using routing software. The memory further includes a tuner manager 224 for controlling tuners in the multimedia gateway 125A. The tuner manager 224 maintains a state and usage of all tuners and their configured parameters. The tuner manager 224 decides whether to allow a certain configuration or not, like low-noise block (LNB) control parameters like polarity depending upon a current state of the tuners. If the tuners are already tuned to a particular polarity, tuner manager may not allow changing the polarity.

A local area network (LAN) 236 act as an integrated router and bridge with a receive side and a transmit side in the multimedia gateway 125A. For the devices in the networked home environment 155, the LAN 236 provides Internet connectivity and acts as a router. For intra device connectivity in the networked home environment 155, the LAN 236 acts as a bridge. A network and gateway manager 210 manages configuration, event logging, and statistics of multimedia gateway software. The multimedia gateway 125A receives signals from OTA 238 which are Advanced Television Systems Committee (ATSC) signals. The ATSC and DVB stack 240 for video and DVB stack 242 for IP controls the tuners and provides required interfaces for applications to handle the tuners. The DVB stacks 240 and 242 provide three interfaces, frontend, Demuxer and netdevice. A recording server 222 manages recording information in the networked home environment 155.

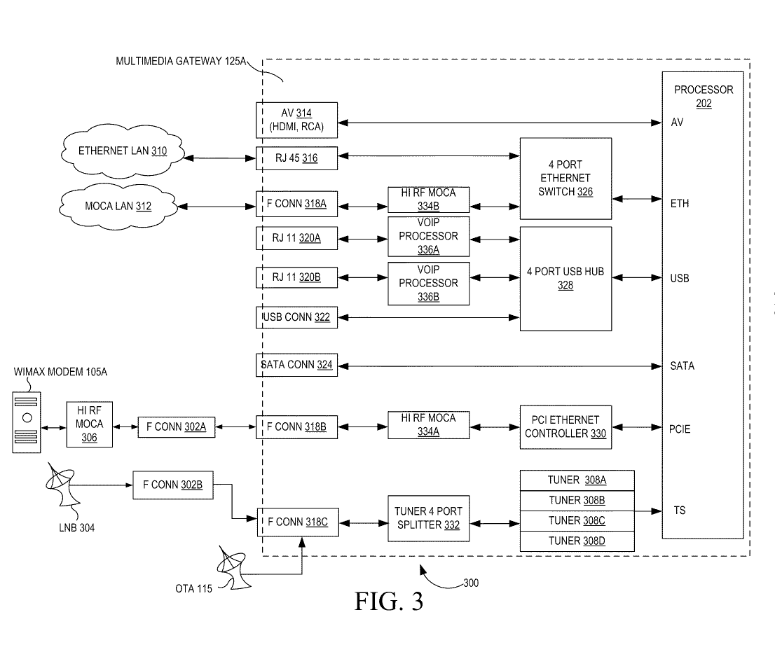

FIG. 3 is a block diagram 300 illustrating hardware architecture of the multimedia gateway 125A of FIG. 1, according to one embodiment. As shown, the multimedia gateway 125A receives signals through the WiMAX modem 105A, LNB 304, Hi RF MOCA 306, the OTA 115, Ethernet LAN 310 and MOCA LAN 312. The multimedia gateway 125A receives the signals through audio video (AV) 314, a RJ 45 316, F connectors 318A-C, RJ 11 320A-B, universal serial bus (USB) connection 322, and serial advanced technology attachment (SATA) connection 324. The signals pass through appropriate channels in the multimedia gateway 125A and through different ports are transmitted to the devices in the networked home environment 155. For example, the signal from OTA 308 received through the F connector 318C passes through a tuner four port splitter 332. Based on the polarity of tuners 308A-D, the signal is outputted to the devices in the networked home environment 155. Similarly, through F connectors 318B, Hi RF MOCA 334A, and PCI Ethernet controller 330, signals are transmitted to PCIE slots.

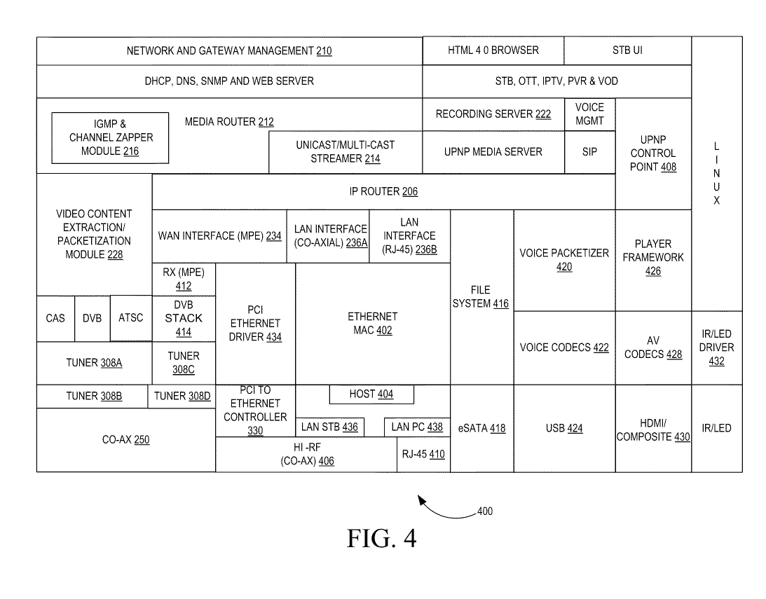

FIG. 4 is a block diagram 400 illustrating more detailed software architecture of the multimedia gateway 125A of FIG. 1, according to one embodiment. FIG. 4 is similar to FIG. 2 except FIG. 4 shows additional major software modules that are not shown in FIG. 2. Particularly, FIG. 4 illustrates the IGMP and channel zapper module 216, the unicast/multicast streamer 214, the IP router 206, the video content extraction/packetization module 228 which are explained in greater detail with respect to FIG. 2. Also, as shown in FIG. 4 are an Ethernet MAC 402, a host 404, Hi RF 406, a RJ-45 410, a UPNP control point 408, RX (MPE) 412, a DVB stack 414, a file system 416, eSATA 418, a voice packetizer 420, voice codecs 422, USB 424, a player framework 426, AV codecs 428, high definition multimedia interface (HDMI) composite 430, infrared/light emitting diode (IR/LED) driver 432.

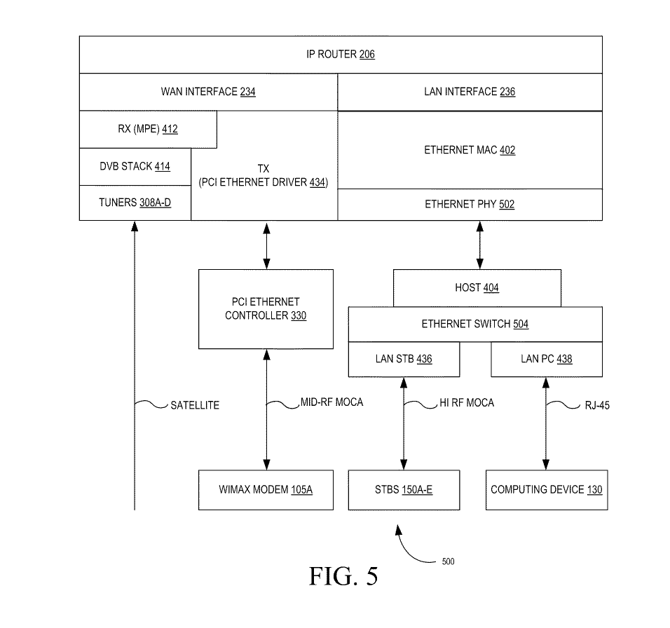

FIG. 5 is a block diagram 500 showing interconnectivity between major LAN and WAN hardware components for IP routing in the multimedia gateway 125A of FIG. 1, according to one embodiment. Also, as shown in FIG. 5, the various interfaces coming in and out of the multimedia gateway 125A, that includes tuners 308A-D, the WAN interface 234, a LAN-STB interface 436 and a LAN-PC interface 438. Further as shown in FIG. 5, the RF signal coming from the satellite 105B is inputted into one of the tuners 308A-D. Furthermore as shown in FIG. 5, the RF signal received from the WiMAX modem 105A is received by a PCI Ethernet drive 434 via the PCI Ethernet controller 330. In the embodiment shown in FIG. 5, the IP router 206 receives the RF signals from the WiMAX modem 105A and the satellite 105B and routes it to the Ethernet MAC 402 and then to an Ethernet PHY 502, which is then sent to the host 404 and then to a Ethernet Switch 504 and then to the spective LAN PC 438 and the LAN STB 436 for sending it to associated STBs and computing devices. In the embodiment shown in FIG. 5, the tuners 308A-D provides a tuning functionality. Further in one embodiment, there are four tuners and out of which three tuners carry video and audio data and the forth tuner is used for receiving IP data.

Also in the embodiment shown in FIG. 5, the WAN interface 234 is an asymmetric interface and includes a WAN receive side and WAN transmit side. The WAN receive side includes the tuners 308A-N, the DVB stack 414 and the RX(MPE) 412. The WAN transmit side includes PCI interface on the processor, an external PCI to Ethernet controller, Hi RF MoCA, and WiMAX modem.

The LAN-STB interface 436 is a symmetric interface and includes a receive side and a transmit side. The receive side includes a LAN STB port, a host port on the VLAN aware switch and Ethernet MAC, ETH PHY on the processor. The transmit side includes an Ethernet MAC, ETH PHY on the processor, host port, LAN STB port on an external 4-port VLAN capable switch, MoCA connected to the STBs.

The LAN-PC interface 438 is a symmetric interface and includes a receive side and a transmit side. The receive side includes a LAN PC port, a host port on the VLAN aware switch and the Ethernet MAC 402, the ETH PHY 502 on the processor. The transmit side includes Ethernet MAC 402, ETH PHY 502 on the processor, host port, LAN PC port on an external 4-port VLAN capable switch, RJ-45 connected to the STBs.

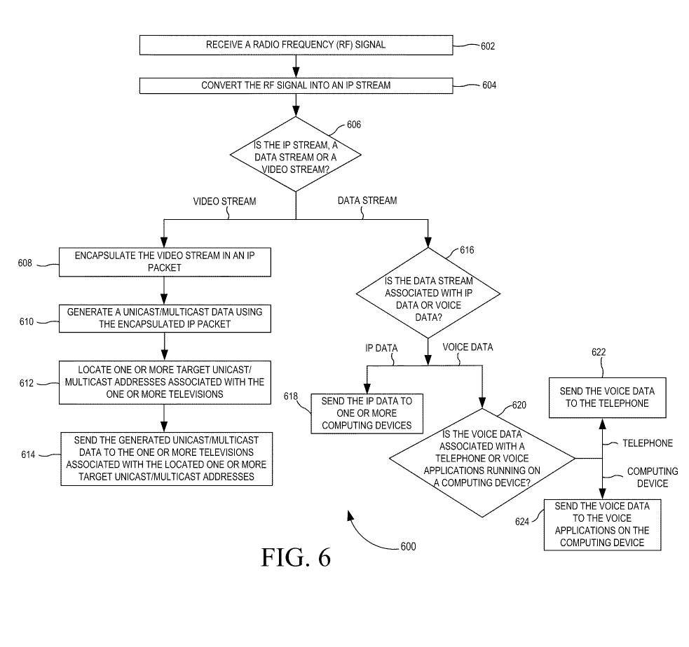

FIG. 6 illustrates a process flow chart 600 of an exemplary method for delivering broadcast multimedia content in a networked home environment, such as those shown in FIG. 1, according to one embodiment. At step 602, a RF signal is received by a RF signal translator (e.g., the RF signal translator 110 of FIG. 1). At step 604, the RF signal is converted into an IP stream. At step 606, it is determined whether the IP stream is an IP data stream or an IP video stream. Based on the outcome of the determination, the IP stream is sent to one or more of televisions (e.g., the televisions 145A-N of FIG. 1), computing devices (e.g., the computing device 130 of FIG. 1), and/or telephones (e.g., the telephone 135 of FIG. 1). If it is determined that the IP stream is IP video stream, step 608 is performed, else step 616 is performed.

At step 608, the IP video stream is encapsulated in an IP packet. The step 608 may be performed if it is determined that the IP video stream is not encapsulated in an IP packet for IP for video. For example, typically, the IP video stream coming from the WiMAX modem is already encapsulated in the IP packet. In such a case, a multimedia gateway (e.g., the multimedia gateway 125A of FIG. 1) would only determine to see if IP video stream is encapsulated for IP for video. Whereas, the RF signal received from a satellite, typically, can have an extra layer of encapsulation and in this case, the multimedia gateway translates the IP video stream including the extra layer of encapsulation for IP for video. Further, the RF signal, typically, received from satellite includes both the IP data stream and the IP video stream, whereas in the case of WiMAX modem, typically, the RF signal includes only the IP data stream, however, in some cases, the RF signal from the WiMAX modem can include both the IP data stream and the IP video stream. Furthermore, the WiMAX modem may also send data, such as acknowledgements to any data received via satellite or WiMAX modem. In these embodiments, the RF signal translator verifies to make sure the IP stream received and/or sent via any of these devices are appropriately encapsulated before sending them for processing by the subsequent modules and/or devices.

At step 610, a unicast/multicast data is generated using the encapsulated IP packet. At step 612, one or more target unicast/multicast addresses associated with the one or more televisions are located. At step 614, the generated unicast/multicast data is sent to the one or more televisions associated with the located one or more target unicast/multicast addresses.

At step 616, it is determined whether the IP data stream is an (IP) data or voice data. For example, the IP data may be TCP/IP data. If it is determined that the IP data stream is the IP data, step 618 is performed, else step 620 is performed. At step 618, the IP data is sent to the one or more computing devices. The computing devices include but not limited to computers, servers, laptops, STBs, gaming consoles, tablets, and mobile phones.

At step 620, it is determined whether the voice data is associated with a telephone or voice applications running on a computing device. If it is determined that voice data is associated with the telephone, the voice data is sent to the telephone at step 622. If it is determined that voice data is associated with the voice applications running on the computing device, the voice data is sent to the voice applications running on associated one or more computing devices at step 624. The voice data is processed and then sent to the telephone and/or the voice applications.

In various embodiments, methods and systems described in FIGS. 1 through 6 enable broadcasting of multimedia content to a plurality of devices in a networked home environment without the need for a separate service provider specific STB for each of the plurality of devices, thereby reducing installation costs and providing the flexibility to the users to use any service provider without having to change the STBs.

Although the present embodiments have been described with reference to specific example embodiments, it will be evident that various modifications and changes may be made to these embodiments without departing from the broader spirit and scope of the various embodiments. Furthermore, the various devices, modules, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

What is claimed is:

1. A method for delivering broadcast multimedia content in a networked home environment, comprising:
receiving a radio frequency (RF) signal;
converting the RF signal into an internet protocol (IP) stream;
determining whether the IP stream is a IP data stream or a IP video stream; and
sending the IP stream to one or more televisions, one or more computing devices, and/or one or more telephones based on the outcome of the determination.

2. The method of claim 1, wherein receiving the RF signal comprises:
receiving the RF signal from a RF signal translator, wherein the RF signal translator receives the RF signal from devices selected from the group consisting of a satellite, and a WiMAX Modem.

3. The method of claim 1, wherein sending the IP stream to the one or more televisions, one or more computing devices, and one or more telephones based on the outcome of the determination comprises:
if the determined IP stream is the IP video stream, then sending the IP video stream to the one or more televisions; and
if the determined IP stream is the IP data stream, then sending the IP data stream to the one or more computing devices and/or the one or more telephones.

4. The method of claim 3, wherein sending the IP video stream to the one or more televisions comprises:
determining whether the IP video stream is encapsulated in an IP packet for IP for video;
translating the IP video stream for the IP for video;
generating a unicast/multicast data using the encapsulated IP packet; and
sending the generated unicast/multicast data to the one or more televisions.

5. The method of claim 4, wherein sending the generated unicast/multicast data to the one or more televisions comprises:
locating one or more target unicast/multicast addresses associated with the one or more televisions; and
sending the generated unicast/multicast data to the one or more televisions associated with the located one or more target unicast/multicast addresses.

6. The method of claim 3, wherein sending the IP data stream to the one or more computing devices and/or one or more telephones comprises:
determining whether the IP data stream is an IP data or voice data;
if the determined IP data stream is the IP data, then sending the IP data to the one or more computing devices; and
if the determined IP data stream is the voice data, then sending the voice data to the one or more telephones.

7. The method of claim 6, wherein the computing devices are selected from the group consisting of personal computers, servers, laptops, set-top boxes (STBs), gaming consoles, tablets, and mobile phones.

8. The method of claim 6, wherein sending the voice data to the one or more telephones comprises:
determining whether the voice data is associated with a telephone or voice applications running on a computing device;
if the determined voice data is associated with the telephone, then sending the voice data to the telephone; and
if the determined voice data is associated with the voice applications running on the computing device, then sending the voice data to the voice applications running on associated one or more computing devices.

9. A non-transitory computer-readable storage medium for delivering broadcast multimedia content in a networked home environment having instructions that, when executed by a computing device causes the computing device to:
receive a RF signal;
convert the RF signal into an IP stream;
determine whether the IP stream is an IP data stream or an IP video stream; and
send the IP stream to one or more of televisions, one or more computing devices, and/or one or more telephones based on the outcome of the determination.

10. The non-transitory computer-readable storage medium of claim 9, wherein receiving the RF signal comprises:
receiving the RF signal from a RF signal translator, wherein the RF signal translator receives the RF signal from devices selected from the group consisting of a satellite, and a WiMAX Modem.

11. The non-transitory computer-readable storage medium of claim 9, wherein sending the IP stream to the one or more of televisions, one or more computing devices, and one or more telephones based on the outcome of the determination comprises:
if the determined IP stream is the IP video stream, then sending the IP video stream to the one or more televisions; and
if the determined IP stream is the IP data stream, then sending the IP data stream to the one or more of computing devices and/or the one or more telephones.

12. A system for delivering broadcast multimedia content in a networked home environment, comprising:
an RF signal translator for receiving an RF signal;
one or more computing devices;
a multimedia gateway communicatively coupled to the RF signal translator and the one or more computing devices; and
a plurality of set-top boxes (STBs), wherein each of the STBs is associated with each one of one or more televisions, and/or one or more telephones, wherein the RF signal translator converts the RF signal into an IP stream, wherein the multimedia gateway determines whether the IP stream is a IP data stream or a IP video stream and sends the IP stream to one or more of the plurality of STBs associated with the one or more televisions, the one or more telephones, and/or the one or more computing devices connected to the multimedia gateway based on the outcome of the determination.

13. The system of claim 12, wherein the RF signal translator receives the RF signal from devices selected from the group consisting of a satellite and a WiMAX modem.

14. The system of claim 12, wherein the multimedia gateway receives IP video stream from equipment capable of sending signals over the air (OTA).

15. The system of claim 12, wherein the multimedia gateway sends the IP video stream to the one or more of the plurality of STBs associated with the one or more televisions, if the determined IP stream is the IP video stream, and wherein the multimedia gateway sends the IP data stream to one or more of the plurality of STBs, associated with the one or more telephones and/or the one or more of the computing devices connected to the multimedia gateway if the determined IP stream is the IP data stream.

16. The system of claim 15, wherein the multimedia gateway encapsulates the IP video stream in an IP packet, wherein the multimedia gateway generates a unicast/multicast data using the encapsulated IP packet, and wherein the multimedia gateway sends the generated unicast/multicast data to the one or more STBs associated with the one or more televisions.

17. The system of claim 16, wherein the multimedia gateway locates one or more target unicast/multicast addresses associated with the one or more televisions, and wherein the multimedia gateway sends the generated unicast/multicast data to the one or more of the plurality of STBs associated with the one or more televisions associated with the located one or more target unicast/multicast addresses.

18. The system of claim 15 wherein the multimedia gateway determines whether the IP data stream is an IP data or voice data, wherein the multimedia gateway sends the IP data to the one or more computing devices, if the determined IP data stream is IP data, and wherein the multimedia gateway sends the voice data to the one or more of the plurality of STBs associated with the one or more telephones if the determined IP data stream is voice data.

19. The system of claim 18, wherein the computing devices are selected from the group consisting of personal computers, servers, laptops, STBs, gaming consoles, tablets, and mobile phones.

20. The system of claim 18, wherein the multimedia gateway determines whether the voice data is associated with the one or more telephones or voice applications running on the one or more computing devices, wherein the multimedia gateway sends the voice data to the one or more of the plurality of STBs associated with the one or more telephones, if the determined voice data is associated with the one or more telephones, and wherein the multimedia gateway sends the voice data to one or more voice applications running on associated one or more computing devices, if the determined voice data is associated with the voice applications running on the one or more computing devices.

21. A multimedia gateway delivering broadcast multimedia content in a networked home environment, comprising:
a processor; and
memory coupled to the processor, wherein the memory includes a video processing module, a voice processing module, a data processing module, a media router, and STB, wherein the processor determines whether received IP stream is a IP data stream or a IP video stream and then sends the IP stream to the video processing module for rendering the signal to one or more STBs associated with one or more of televisions, sends the IP stream to the data processing module for rendering the signal to one or more computing devices, and/or sends the IP stream to the voice processing module for rendering the signal one or more STBs associated with one or more telephones based on the outcome of the determination.

22. The multimedia gateway of claim 21, wherein the video processing module includes a video content extraction/packetization module, an IP stream encapsulation module, and an IP stream classification module, and wherein the processor sends the IP stream to the video processing module if the IP stream is the IP video stream, wherein the video content extraction/packetization module extracts the IP video stream from the IP stream, wherein the IP stream encapsulation module encapsulates the extracted IP video stream into an IP packet, and the IP stream classification module generates a unicast/multicast data using the encapsulated IP packet.

23. The multimedia gateway of claim 21, wherein the media router includes an IGMP and channel zapper module and a unicast/multicast streamer, wherein the IGMP and channel zapper module maintains a list of channels, tuner parameters, and tunes a required channel in the one or more televisions, and wherein the unicast/multicast streamer streams the unicast/multicast data.

24. The multimedia gateway of claim 21, wherein the processor sends the IP stream to the data processing module if the IP stream is IP data for rendering the IP data to the one or more computing devices.

25. The multimedia gateway of claim 24, wherein the computing devices are selected from the group consisting of personal computers, servers, laptops, STBs, gaming consoles, tablets, and mobile phones.

26. The multimedia gateway of claim 21, wherein the processor sends the IP stream to the voice processing module if the IP stream is voice data for rendering the voice data to the one or more STBs associated with the one or more telephones.

27. The multimedia gateway of claim 26, wherein the voice processing module determines whether voice data is associated with one or more telephones or one or more voice applications running on the one or more computing devices, wherein the voice processing module sends the voice data to the one or more STBs associated with the one or more telephones, if the voice data is associated with the one or more telephones, and wherein the voice processing module sends the voice data to the one or more computing devices if the voice data is associated with the one or more voices applications running on the one or more computing devices.
